(19) United States
(12) Patent Application Publication
(10) Pub. No.: US 2017/0037282 A1
(43) Pub. Date: Feb. 9, 2017

(54) ADHESIVES COMPRISING (METH)ALLYL CROSSLINKER AND METHODS

(71) Applicant: 3M INNOVATIVE PROPERTIES COMPANY, St. Paul, MN (US)

(72) Inventors: Corinne E. Lipscomb, St. Paul, MN (US); Kevin M. Lewandowski, Inver Grove Heights, MN (US); Jonathan E. Janoski, Woodbury, MN (US); Jayshree Seth, Woodbury, MN (US); Arlin L. Weikel, Mansfield, PA (US); John W. Vanderzanden, Maplewood, MN (US)

(73) Assignee: 3M INNOVATIVE PROPERTIES COMPANY, St. Paul, MN (US)

(21) Appl. No.: 15/303,041

(22) PCT Filed: Apr. 8, 2015
(86) PCT No.: PCT/US2015/024801

§ 371 Date: Oct. 10, 2016

Related U.S. Application Data
(60) Provisional application No. 61/978,217, filed on Apr. 11, 2014.

(51) Int. Cl. C09J 7/02; C08K 7/28; C08K 3/36; C08F 220/18; C09J 133/08

(52) U.S. Cl. CPC C09J 7/0217; C08F 220/18; C09J 133/08; C08K 3/36; C08K 7/28; C08F 2220/1858; C09J 2201/606; C09J 2205/114

(57) ABSTRACT

Pressure sensitive adhesive compositions are described comprising polymerized units derived from alkyl (meth)acrylate monomer(s) and a crosslinking monomer comprising at least two terminal groups selected from allyl, methallyl, or combinations thereof. In one embodiment, the pressure sensitive adhesive composition is a syrup or the reaction product of a syrup comprising i) a free-radically polymerizable solvent monomer; and ii) a solute (meth)acrylic polymer The syrup or the (meth)acrylic solute polymer comprises polymerized units derived from the cross-linking monomer. Also described are pressure sensitive adhesive articles and methods.

### BACKGROUND

As described in WO 2012/177337, there are two major crosslinking mechanisms for acrylic adhesives: free-radical copolymerization of multifunctional ethylenically unsaturated groups with the other monomers, and covalent or ionic crosslinking through the functional monomers, such as acrylic acid. Another method is the use of UV crosslinkers, such as copolymerizable benzophenones or post-added photocrosslinkers, such as multifunctional benzophenones and triazines. In the past, a variety of different materials have been used as crosslinking agents, e.g., polyfunctional acrylates, acetophenones, benzophenones, and triazines. The foregoing crosslinking agents, however, possess certain drawbacks which include one or more of the following: high volatility; incompatibility with certain polymer systems; generation of undesirable color; requirement of a separate photoactive compound to initiate the crosslinking reaction; and high sensitivity to oxygen. A particular issue for the electronics industry and other applications in which PSAs contact a metal surface is the generation of corrosive by-products and the generation of undesirable color.

### BRIEF DESCRIPTION OF THE DRAWINGS

FIG. 1 depicts the tan delta, the ratio of the shear loss modulus (G″) to the shear storage modulus (G′), as determined by dynamic mechanical analysis.

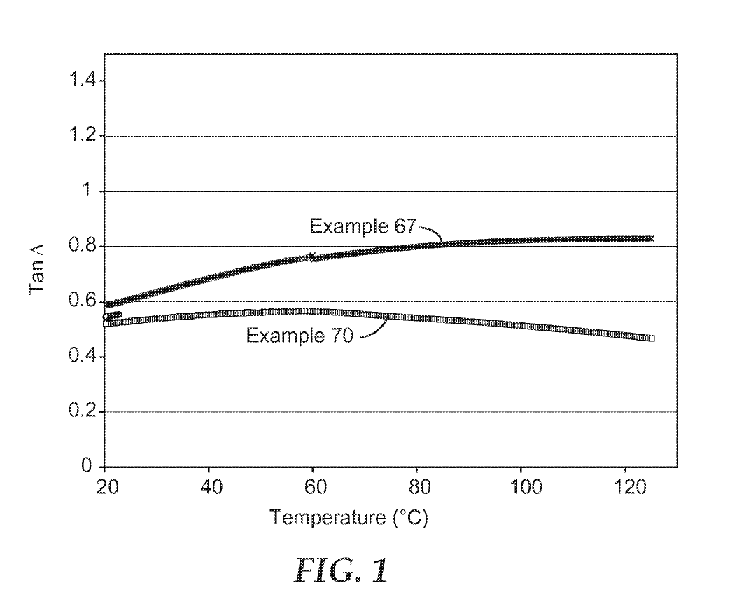

### SUMMARY

Thus, industry would find advantage in alternative crosslinkers for (e.g. pressure sensitive) adhesives.

In one embodiment, a pressure sensitive adhesive composition is described comprising a syrup or the reaction product of a syrup comprising i) a free-radically polymerizable solvent monomer; and ii) a solute (meth)acrylic polymer comprising polymerized units derived from one or more alkyl (meth)acrylate monomers. The syrup comprises at least one crosslinking monomer or the (meth)acrylic solute polymer comprises polymerized units derived from at least one crosslinking monomer. The crosslinking monomer comprising at least two terminal groups selected from allyl, methallyl, or combinations thereof. The terminal groups independently have the formula H₂C═C(R¹)CH₂—, wherein R¹ is hydrogen or methyl.

In other embodiments, pressure sensitive adhesive articles are described comprising the pressure sensitive adhesive composition described herein disposed on a release liner or on a backing.

Also described is a method of preparing a pressure sensitive adhesive composition. The method comprises a) providing a syrup as described herein, b) applying the syrup to a substrate, and c) irradiating the applied syrup thereby crosslinking the adhesive composition.

In yet another embodiment, a pressure sensitive adhesive composition is described comprising at least 50 wt-% of polymerized units derived from alkyl (meth)acrylate monomer(s) and 0.2 to 15 wt-% of at least one crosslinking monomer wherein the crosslinking monomer has the formula

(H₂C═C(R¹)(CH₂)_{y})ₓZ
wherein R¹ is hydrogen or methyl;
Z is oxygen, nitrogen, or a multivalent linking group;
y is 5-20; and
x ranges from 2-6.

### DETAILED DESCRIPTION

The present disclosure describes pressure sensitive adhesives (PSAs) prepared from crosslinkable (e.g. syrup) compositions, as well as articles. The crosslinked pressure-sensitive adhesives provide a suitable balance of tack, peel adhesion, and shear holding power. Further, the storage modulus of the pressure sensitive adhesive at the application temperature, typically room temperature (25° C.), is less than 3×10⁶ dynes/cm² at a frequency of 1 Hz. In some embodiments, the adhesive is a pressure sensitive adhesive at an application temperature that is greater than room temperature. For example, the application temperature may be 30, 35, 40, 45, 50, 55, or 65° C. In this embodiment, the storage modulus of the pressure sensitive adhesive at room temperature (25° C.) is typically greater than 3×10⁶ dynes/cm² at a frequency of 1 Hz. In some embodiments, the storage modulus of the pressure sensitive adhesive at room temperature (25° C.) is less than 2×10⁶ dynes/cm² or 1×10⁶ dynes/cm² at a frequency of 1 Hz.

“Syrup composition” refers to a solution of a solute polymer in one or more solvent monomers, the composition having a viscosity from 100 to 8,000 cPs at 25° C. The viscosity of the syrup is greater than the viscosity of the solvent monomer(s).

Herein, “(meth)acryloyl” is inclusive of (meth)acrylate and (meth)acrylamide.

Herein, “(meth)acrylic” includes both methacrylic and acrylic.

Herein, “(meth)acrylate” includes both methacrylate and acrylate.

The term “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, 2-octyl, n-heptyl, ethylhexyl, cyclopentyl, cyclohexyl, cycloheptyl, adamantyl, and norbornyl, and the like. Unless otherwise noted, alkyl groups may be mono- or polyvalent.

The term heteroalkyl refers to an alkyl group, as just defined, having at least one catenary carbon atom (i.e. in-chain) replaced by a catenary heteroatom such as O, S, or N.

“Renewable resource” refers to a natural resource that can be replenished within a 100 year time frame. The resource may be replenished naturally or via agricultural techniques. The renewable resource is typically a plant (i.e. any of various photosynthetic organisms that includes all land plants, inclusive of trees), organisms of Protista such as seaweed and algae, animals, and fish. They may be naturally occurring, hybrids, or genetically engineered organisms. Natural resources such as crude oil, coal, and peat which take longer than 100 years to form are not considered to be renewable resources.

When a group is present more than once in a formula described herein, each group is “independently” selected unless specified otherwise.

The adhesive comprises a (meth)acrylic polymer prepared from one or more monomers common to acrylic adhesives, such as a (meth)acrylic ester monomers (also referred to as (meth)acrylate acid ester monomers and alkyl(meth)acrylate monomers) optionally in combination with one or more other monomers such as acid-functional ethylenically unsaturated monomers, non-acid-functional polar monomers, and vinyl monomers.

The (meth)acrylic polymer comprises one or more (meth)acrylate ester monomers derived from a (e.g. non-tertiary) alcohol containing from 1 to 14 carbon atoms and preferably an average of from 4 to 12 carbon atoms.

Examples of monomers include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, and the like. In some embodiments, a preferred (meth)acrylate ester monomer is the ester of (meth)acrylic acid with isooctyl alcohol.

In some favored embodiments, the monomer is the ester of (meth)acrylic acid with an alcohol derived from a renewable source. A suitable technique for determining whether a material is derived from a renewable resource is through ¹⁴C analysis according to ASTM D6866-10, as described in US2012/0288692. The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

One suitable monomer derived from a renewable source is 2-octyl (meth)acrylate, as can be prepared by conventional techniques from 2-octanol and (meth)acryloyl derivatives such as esters, acids and acyl halides. The 2-octanol may be prepared by treatment of ricinoleic acid, derived from castor oil, (or ester or acyl halide thereof) with sodium hydroxide, followed by distillation from the co-product sebacic acid. Other (meth)acrylate ester monomers that can be renewable are those derived from ethanol and 2-methyl butanol.

In some embodiments, the (e.g. pressure sensitive) adhesive composition (e.g. (meth)acrylic polymer and/or free-radically polymerizable solvent monomer) comprises a bio-based content of at least 25, 30, 35, 40, 45, or 50 wt-% using ASTM D6866-10, method B. In other embodiments, the (e.g. pressure sensitive) adhesive composition comprises a bio-based content of at least 55, 60, 65, 70, 75, or 80 wt-%. In yet other embodiments, the (e.g. pressure sensitive) adhesive composition comprises a bio-based content of at least 85, 90, 95, 96, 97, 99 or 99 wt-%.

The (e.g. pressure sensitive) adhesive (e.g. (meth)acrylic polymer and/or free-radically polymerizable solvent monomer) comprises one or more low Tg (meth)acrylate monomers, having a Tg no greater than 10° C. when reacted to form a homopolymer. In some embodiments, the low Tg monomers have a Tg no greater than 0° C., no greater than −5° C., or no greater than −10° C. when reacted to form a homopolymer. The Tg of these homopolymers is often greater than or equal to −80° C., greater than or equal to −70° C., greater than or equal to −60° C., or greater than or equal to −50° C. The Tg of these homopolymers can be, for example, in the range of −80° C. to 20° C., −70° C. to 10° C., −60° C. to 0° C., or −60° C. to −10° C.

The low Tg monomer may have the formula

H₂C═CR¹C(O)OR⁸

wherein R¹ is H or methyl and R⁸ is an alkyl with 1 to 22 carbons or a heteroalkyl with 2 to 20 carbons and 1 to 6 heteroatoms selected from oxygen or sulfur. The alkyl or heteroalkyl group can be linear, branched, cyclic, or a combination thereof.

Exemplary low Tg monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate.

Low Tg heteroalkyl acrylate monomers include, but are not limited to, 2-methoxyethyl acrylate and 2-ethoxyethyl acrylate.

In some embodiments, the (e.g. pressure sensitive) adhesive (e.g. (meth)acrylic polymer and/or free radically polymerizable solvent monomer) comprises low Tg monomer(s) having an alkyl group with 6 to 20 carbon atoms. In some embodiments, the low Tg monomer has an alkyl group with 7 or 8 carbon atoms. Exemplary monomers include, but are not limited to, 2-ethylhexyl methacrylate, isooctyl methacrylate, n-octyl methacrylate, 2-octyl methacrylate, isodecyl methacrylate, and lauryl methacrylate. Likewise, some heteroalkyl methacrylates such as 2-ethoxy ethyl methacrylate can also be used.

In some embodiments, the (e.g. pressure sensitive) adhesive (e.g. (meth)acrylic polymer and/or free-radically polymerizable solvent monomer) comprises a high Tg monomer, having a Tg greater than 10° C. and typically of at least 15° C., 20° C., or 25° C., and preferably at least 50° C. Suitable high Tg monomers include, for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate or combinations.

In some embodiments, the (meth)acrylic polymer is a homopolymer. In other embodiments, the (meth)acrylic polymer is a copolymer. Unless specified otherwise, the term polymer refers to both a homopolymer and copolymer.

The Tg of the copolymer may be estimated by use of the Fox equation, based on the Tgs of the constituent monomers and the weight percent thereof.

The alkyl (meth)acrylate monomers are typically present in the (meth)acrylic polymer in an amount of at least 85, 86, 87, 88, 89, or 90 up to 95, 96, 97, 98, or 99 parts by weight, based on 100 parts by weight of the total monomer or polymerized units. When high Tg monomers are included in a pressure sensitive adhesive, the adhesive may include at least 5, 10, 15, 20, to 30 parts by weight of such high Tg monomer(s).

When the (e,g. pressure sensitive) adhesive composition is free of unpolymerized components, such as tackifier, silica, and glass bubbles, the parts by weight of the total monomer or polymerized units is approximately the same as the wt-% present in the total adhesive composition. However, when the (e.g. pressure sensitive) adhesive composition comprises such unpolymerized components, the (e.g. pressure sensitive) adhesive composition can comprises substantially less alkyl(meth)acrylate monomer(s) and crosslinking monomer. The (e.g. pressure sensitive) adhesive composition comprises at least 50 wt-% of polymerized units derived from alkyl (meth)acrylate monomers. In some embodiments, the pressure sensitive adhesive composition comprises at least 50, 55, 60, 65, 70, 75, 80, 85, or 90 wt-% of one or more low Tg monomers.

The (meth)acrylic polymer may optionally comprise an acid functional monomer (a subset of high Tg monomers), where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof.

Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. In some embodiments, the acid functional monomer is generally used in amounts of 0.5 to 15 parts by weight, preferably 0.5 to 10 parts by weight, based on 100 parts by weight total monomer or polymerized units. In some embodiments, the (meth)acrylic polymer and/or PSA comprises less than 1.0, 0.9, 0.8, 0.7, 0.6, 0.5, 0.4, 0.3, 0.2, 0.1 or 0 wt-% of polymerized units derived from acid-functional monomers such as acrylic acid.

The (meth)acrylic copolymer may optionally comprise other monomers such as a non-acid-functional polar monomer.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone. The non-acid-functional polar monomer may be present in amounts of 0 to 10 or 20 parts by weight, or 0.5 to 5 parts by weight, based on 100 parts by weight total monomer. In some embodiments, the (meth)acrylic polymer and/or PSA comprises less than 1.0, 0.9, 0.8, 0.7, 0.6, 0.5, 0.4, 0.3, 0.2, 0.1 or 0 wt-% of polymerized units derived from non-acid polar monomers.

When used, vinyl monomers useful in the (meth)acrylate polymer include vinyl esters (e.g., vinyl acetate and vinyl propionate), styrene, substituted styrene (e.g., a-methyl styrene), vinyl halide, and mixtures thereof. As used herein vinyl monomers are exclusive of acid functional monomers, acrylate ester monomers and polar monomers. Such vinyl monomers are generally used at 0 to 5 parts by weight, preferably 1 to 5 parts by weight, based on 100 parts by weight total monomer or polymerized units. In some embodiments, the (meth)acrylic polymer and/or PSA comprises less than 1.0, 0.9, 0.8, 0.7, 0.6, 0.5, 0.4, 0.3, 0.2, 0.1 or 0 wt-% of polymerized units derived from vinyl monomers.

The pressure sensitive adhesive further comprises a crosslinking monomer comprising at least two terminal groups selected from allyl, (meth)allyl, or combinations thereof. An allyl group has the structural formula H₂C═CH—CH₂—. It consists of a methylene bridge (—CH₂—) attached to a vinyl group (—CH═CH₂). Similarly, a (meth)ally group is a substituent with the structural formula H₂C═C(CH₃)—CH₂—.

The crosslinking monomers are typically free of vinyl groups, such as vinyl ethers. Vinyl, also known as ethenyl, is the functional group —CH═CH₂, namely the ethylene molecule (H₂C═CH₂) minus one hydrogen atom.

In one embodiment, the crosslinking monomer comprise two (meth) allyl groups and a (meth)acrylate group. A crosslinking monomer of this type is commercially available from Sartomer, under the trade designation “SR 523”. However, in typical embodiments, the crosslinking monomer is free of (meth)acrylate groups. The lower reactivity of the (meth)allyl group, as compared to a (meth)acrylate group, can be amendable to achieving an optimal amount of crosslinking, especially when the adhesive is cured by (e.g. UV) radiation.

The crosslinking monomer typically has the formula

(H₂C═C(R¹)CH₂)ₓZ
wherein
R¹ is hydrogen or methyl,
Z is a heteroatom or multivalent linking group, and
x ranges from 2 to 6.

In some embodiments, y is 5-20. In some embodiments, x is 2 or 3.

For embodiments wherein the crosslinking monomer comprises a multivalent linking group, the linking group, Z, typically has a molecular weight no greater than 1000 g/mole and in some embodiments no greater than 500 g/mole, 400 g/mole, 300 g/mole, 200 g/mole, 100 g/mole, or 50 g/mole.

Various crosslinking monomers comprising at least two allyl and/or (meth)allyl groups are commercially available. Representative species of commercially available crosslinking monomers are described in the following Table A. Although these species comprise allyl groups, in many embodiments the same species with (meth)allyl groups are available or can be synthesized. For example, (meth)allyl adipate can be prepared in the manner described in the forthcoming examples.

TABLE A

| Name | Formula |
|---|---|
| allyl ether | 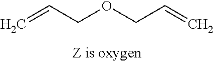 |
| triallyl amine | 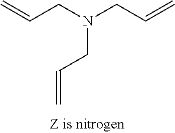 |
| 1,11-dodecadiene | 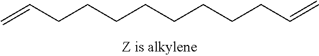 |
| ethylene glycol diallyl ether | 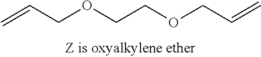 |
| diallyl adipate | 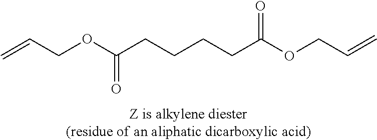 [SMILES: C=CCOC(=O)CCCCC(=O)OCC=C] |
| diallyl sebacate | 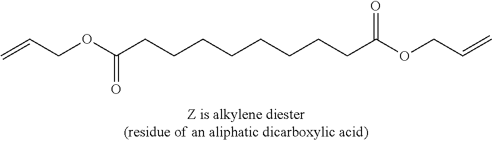 [SMILES: C=CCOC(=O)CCCCCCCCC(=O)OCC=C] |
| diallyl maleate | 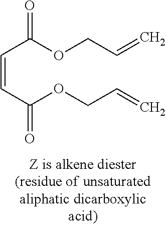 |
| diallyl terephthalate | 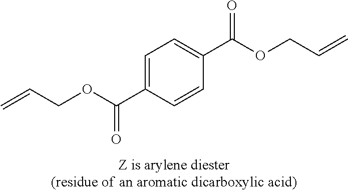 [SMILES: C=CCOC(=O)c1ccc(C(=O)OCC=C)cc1] |
| diallyl isophthalate | 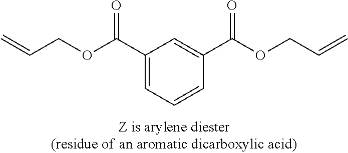 [SMILES: C=CCOC(=O)c1cccc(C(=O)OCC=C)c1] |
| triallyl cyanurate | 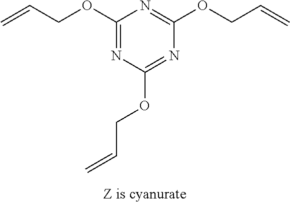 [SMILES: C=CCOc1nc(OCC=C)nc(OCC=C)n1] |
| triallyl isocyanurate | 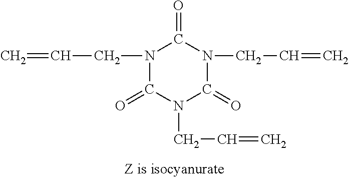 [SMILES: C=CCn1c(=O)n(CC=C)c(=O)n(CC=C)c1=O] |
| trimethylolpropane diallyl ether | 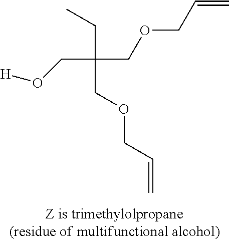 |
| pentaerythritol allyl ether | 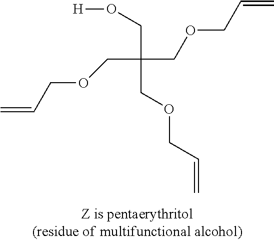 [SMILES: C=CCOCC(CO)(COCC=C)COCC=C] |
| 1,3-diallyl urea | 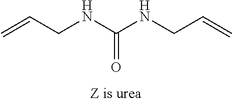 |
| diallyl carbonate | 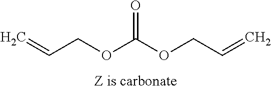 |
| dially(dimethyl)silane | 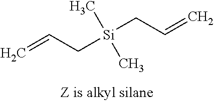 |

Crosslinking monomers comprising at least two allyl and/or (meth)allyl groups can also be synthesized in accordance with various reaction schemes known in the art.

In one reaction scheme, an aryl or heteroaryl magnesium compound can be reacted with an allylic halide (e.g. bromine) as described in Krasovskiy, Straub, and Knochel: Angewandte Chemie—International Edition, 2006 , vol. 45, p. 159-162.

Suitable allylic halides include for example allyl chloride, allyl bromide, allyl iodide, 4-bromo-1-butene, 3-chloro-2-methyl propene, 3-bromo-2-methyl propene, 5-bromo-1-pentene, 6-bromo-1-hexene, 8-bromo-1-octene, 10-chloro-1-decene, and 11-chloro-1-undecene.

Such reaction scheme can produce for example diallyl benzene, depicted as follows:

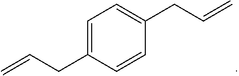

In this embodiment, the multivalent linking group, Z, is arylene.

Various reaction schemes for preparing the crosslinking monomers described herein utilize an (meth)allylic alcohol as a starting material. Thus, the (meth)allyl groups are the reaction product of an allylic or (meth)allylic alcohol.

Various (meth)allylic alcohols can be used in such reaction schemes including for example allyl alcohol 2-methyl-2-propen-1-ol, 2-ethyl-2-propen-1-ol, 2-pentyl-2-propen-1-ol, 10-undecen-1-ol, 3-buten-1-ol, 3-methyl-3-buten-1-ol, 4-penten-1-ol, 5-hexen-1-ol, 9-decen-1-ol and 2-allyloxyethanol. In some embodiments, the crosslinking monomer is a reaction product of a (meth)allylic alcohol comprising at least 8, 9 or 10 carbon atoms. Such alcohols typically comprise (meth)allyl group and an alkylene group comprising at least 5, 6, 7, or 8 carbon atoms and typically no greater than 20, 18 or 16 carbon atoms. In some embodiments, the (meth)allylic alcohol comprises no greater than 12 carbon atoms, and thus comprises an alkylene group with no greater than 9 carbon atoms. Thus, in various embodiments wherein Z comprises an alkylene group, the alkylene group may comprise at least 5, 6, 7, or 8 carbon atoms and typically no greater than 20, 18 or 16 carbon atoms.

Various alkoxylated allylic alcohols can also be used in such reaction schemes. Suitable alkoxylated allylic alcohols have the general formula:

H₂C═C(R¹)CH₂-(A)ₙ-OH

wherein R¹ is hydrogen or methyl; A is a C₂-C₄ oxyalkylene group and especially C₂H₄O— optionally in combination with C₃H₆₀—; and n typically averages 1 to 5. In this embodiment, Z comprises or consists of an oxyalkylene group or a polyoxyalkylene group. One representative compound is ethylene glycol diallyl ether, depicted in Table A.

In other embodiments, Z comprises a (e.g. single) ether group and alkylene groups. The crosslinking monomer may have the formula

H₂C═C(R¹)(CH₂)_{y}—O—(CH₂)_{y}(R¹)C═CH₂
wherein y ranges from 2-20; and
R¹ is hydrogen or methyl.

In some embodiments, y is at least 5, 6, 7, or 8.

Such crosslinking monomers can be prepared by reaction of an allylic alcohols, as previously described, or thiols as described in Marvel and Cripps; Journal of Polymer Science, 1952, vol. 8, p. 313-320. One illustrative reaction scheme utilizing 10-undecen-1-ol to produces undecenyl ether, depicted as follows:

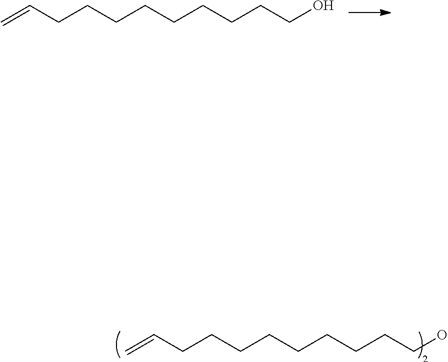

In others embodiments, Z is a reaction product of a multifunctional alcohol having 2 to 6 hydroxyl groups. In this embodiment, the crosslinking monomer typically has the formula

(H₂C═C(R¹)(CH₂)O)ₓL²
wherein L² is a linear or branched (C₁-C₁₂) alkylene optionally comprising one or more substituents such as hydroxyl groups or alkoxy groups;
x ranges from 2 to 6; and
R¹ is hydrogen or methyl.

In some embodiments, x is at least 2, such as in the case of butane diol (meth)ally ether.

In other embodiments, x is at least 3 and L² is a residue of a multifunctional alcohol such as glycerol, trimethylolpropane, trimethylolpropane ethoxylate, trimethylolpropane propoxylate, pentaerythritol, 1,2,4-butanetriol, 1,1,1-tris(hydroxymethyl)ethane, fructose, glucose, 1,3,5-tris(2-hydroxyethyl)isocyanurate, dipentaerythritol, and di(trimethylolpropane). Representative examples of such crosslinking monomers include for example trimethylolpropane diallyl ether and pentaerythritol allyl ether depicted above in Table A.

In yet other embodiments, Z comprises or consists of an ester group. In some embodiments, the crosslinking monomer comprises a single ester group, typically bonded to a C₁-C₂₀ alkylene group and in some embodiments a (C₁-C₁₂) alkylene group. Such crosslinking monomer can be prepared by the reaction of (meth)allylic alcohols, as previously described, with (meth)allylic acids, as described for example in Frostick et al., Journal of the American Chemical Society, 1959, vol. 81, p. 3350-3352. When (meth)allylic acids are utilized as the starting material for producing the (meth)allyl group(s) of the crosslinking monomer, the acid is chosen such that the double bond is spaced from the acid group by a (C₁-C₂₀) alkylene group. Representative acids include for example 3-butenoic acid, 4-pentenoic acid, 2,2-dimethyl-4-pentenoic acid, 5-hexenoic acid, 6-heptenoic acid, 9-decenoic acid, and 10-undecenoic acid. One illustrative reaction scheme is as follows:

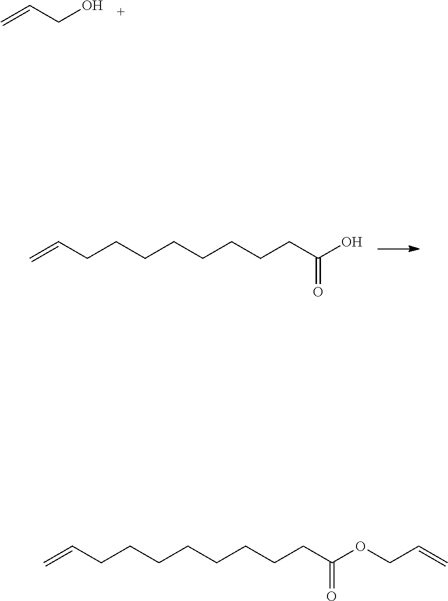

In other embodiments, Z comprises more than one ester group (e.g. diester). In this embodiment, the crosslinking monomer typically has the formula

H₂C═C(R¹)(CH₂)_{y}OC(O)-L³-C(O)O(CH₂)_{y}(R¹)C═CH₂, or

H₂C═C(R¹)(CH₂)_{y}C(O)O-L³-OC(O)(CH₂)_{y}(R¹)C═CH₂)
wherein R¹ is hydrogen or methyl;
L³ is (e.g. C₁-C₂₀) alkylene, arylene, or a combination thereof; and
y ranges from 1 to 20.

In some embodiments, y is at least 5, 6, 7, or 8.

Such crosslinking monomers are typically the residue of an aliphatic or aromatic dicarboxylic acid or diol. Representative examples of such crosslinking monomers include di(meth)allylsebacate, di(meth)allyladipate, di(meth)allylterephthalate, di(meth)allylisophthalate; the dially structures depicted in Table A. Others examples include di(meth)allylitaconate, di(meth)allylmaleate, di (meth)allyl fumarate, di(meth)allyldiglycolate, di(meth)allyl oxalate, di(meth)allyl succinate, and 1,4-butanediol di(undecenylate) depicted as follows:

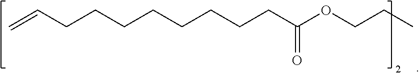

In yet other embodiments, Z comprises or consists of an amide group. In some embodiments, the crosslinking monomer comprises a single amide group, typically bonded to a (C₁-C₂₀) alkylene group and in some embodiments a C₁-C₁₂ alkylene group. In this embodiment, the crosslinking monomer typically has the formula

H₂C═C(R¹)(CH₂)_{y}—N(R⁵)C(O)—(CH₂)_{y}(R¹)C═CH₂
wherein R¹ is hydrogen or methyl;
R⁵ is hydrogen, (C₁-C₆) alkyl, or aryl; and
y ranges from 1 to 20.

In some embodiments, y is at least 5, 6, 7, or 8.

Such crosslinking monomers can be prepared by the reaction of (meth)allylic acids, as previously described, with allylic amines, as described for example in Goldring, Hodder, Weiler; Tetrahedron Letters, 1998, vol. 39, #28 p. 4955-4958. Representative amines include for example allyl amine, N-methyl allylamine, diallyl amine, triallyl amine, tris(2-methallylamine), and N-allyl cyclohexylamine. One illustrative reaction scheme is as follows:

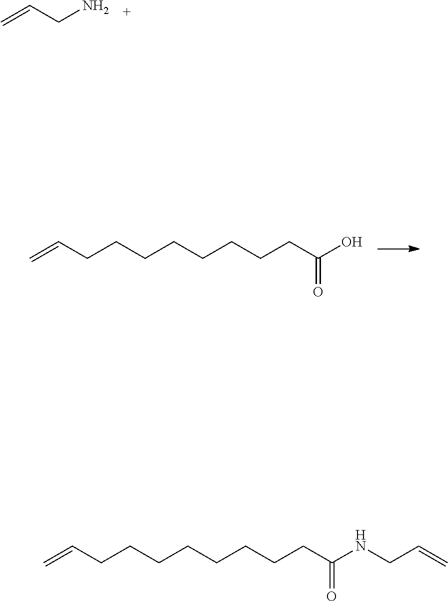

In yet another embodiment, (meth)allylic acids, as previously described can be reacted with a diamine. Conversely, the previously described allylic amines can be reacted with a dicarboxylic or tricarboxylic acid. In this embodiment, Z comprises more than one (e.g. 2 or 3) amide groups. In this embodiment, the crosslinking monomer typically has the formula

H₂C═C(R¹)(CH₂)_{y}C(O)N(R¹)-L³-N(R⁵)C(O)(CH₂)_{y}(R¹)C═CH₂; or

H₂C═C(R¹)(CH₂)_{y}N(R⁵)C(O)-L³-C(O)N(R⁵)(CH₂)_{y}(R¹)C═CH₂
wherein R¹ is hydrogen or methyl;
R⁵ is hydrogen, (C₁-C₆) alkyl, or aryl;
L³ is (e.g. C₁-C₂₀) alkylene, arylene, or a combination thereof; and
y ranges from 1 to 20.

In some embodiments, y is at least 5, 6, 7, or 8.

One representative structure is N,N′-butanediyl-bis-undecenylamide, depicted as follows:

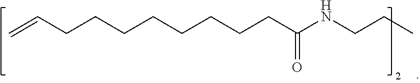

In yet other embodiments, Z comprises or consists of a urethane urea, or carbonate group. Such crosslinking monomers can be formed by reaction of the previously described (meth)allylic alcohols or (meth)allylic amines and an isocyanate. Alternatively an alcohol or polyol lacking a (meth)allyl group can be reacted with allyl isocyanate. Various isocyanates are known including for example hexamethylene diisocyanate (HDI), HDI biuret, HDI dimer, HDI trimer, HDI allophanate, isophorone diisocyanate (IPDI), IPDI trimer, IPDI allophanate, bis(isocyanatocyclohexyl)methane, and the like, and mixtures thereof. Thus, Z can be a residue of an aliphatic or aromatic isocyanate compound.

In this embodiment, the crosslinking monomer typically has the formula

(H₂C═C(R¹)(CH₂)_{y}R⁴C(O)R⁴)ₓL⁴
wherein R¹ is hydrogen or methyl;
R⁴ can be oxygen or NR⁵, wherein R⁵ is hydrogen, (C₁-C₆) alkyl, or aryl;
L⁴ is a residue of a multi-isocyanate, multi-amine compound, or multi-alcohol compound;
y is 1 to 20; and
x is ranges from 2-6.

In some embodiments, x is 2 or 3. In some embodiments, y is at least 5, 6, 7, or 8.

One illustrative reaction scheme of allyl alcohol and allyl isocyanate is as follows:

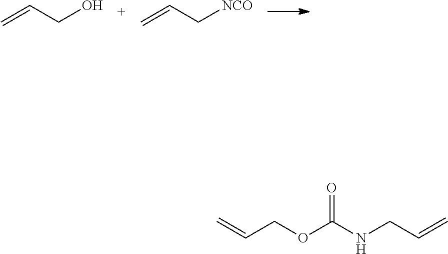

In this embodiment, Z is a single urethane.

Crosslinking monomers comprising urethane or urea groups are described in U.S. Pat. No. 6,780,951; incorporated herein by reference. Representative crosslinking monomer include diallylisophorone urethane and diundecenyl isophorone urethane, depicted as follows

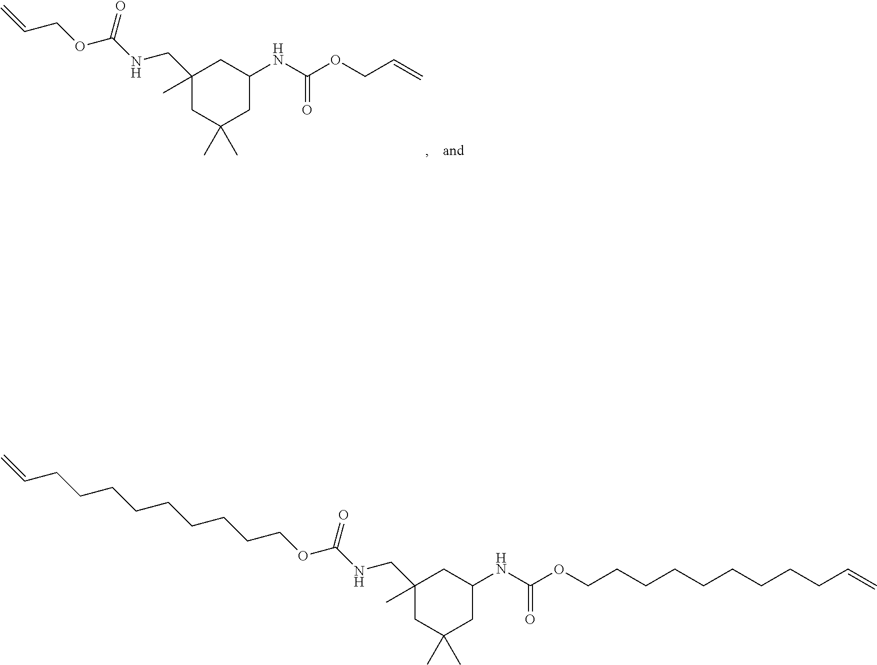 [SMILES: C=CCOC(=O)NCC1(C)CC(NC(=O)OCC=C)CC(C)(C)C1 ; C=CCCCCCCCCCOC(=O)NCC1(C)CC(NC(=O)OCCCCCCCCCC=C)CC(C)(C)C1]

In view of the various crosslinking monomers described herein Z can be a heteratom, such as nitrogen or oxygen, as well as a wide variety of multivalent (e.g. di-, tri-) linking groups. Z can comprise for example (C₁-C₂₀ or C₅-C₂₀) alkylene, arylene, oxyalkylene (e.g. polyoxyalkylene), ester (e.g. monoester, diesters, residues of aliphatic and aromatic carboxylic acids), ether (e.g. residues of multifunctional alcohols), cyanurate, isocyanurate, amide, amine urea, urethane, carbonate, and (C₁-C₄ alkyl) silane. In some embodiments, Z comprises only one of such multivalent linking groups. In other embodiments, Z comprises more than one of the same class of multivalent linking groups (e.g. diester, triether). In yet other embodiments, Z comprises combinations of different classes of multivalent linking groups such as an ester, ether, carbonate, amide, urea, or urethane and an (C₁-C₂₀ or C₁-C₅) alkylene or arylene group.

The concentration of crosslinking monomer comprising at least two (meth)allyl groups is typically at least 0.1, 0.2, 0.3, 0.4 or 0.5 wt-% and can range up to 10, 11, 12, 13, 14, or 15 wt-%. However, as the concentration of such crosslinking monomer increases, the peel adhesion (180° to stainless steel) can decrease. Thus, in typically embodiments, the concentration of such crosslinking monomer is no greater than 9, 8, 7, 6, or 5 wt-% and in some favored embodiments, no greater than 4, 3, 2, or 1 wt-%.

The (e.g. pressure sensitive) adhesive composition may comprise a single crosslinking monomer comprising at least two (meth)allyl groups, or a combination of two or more of such crosslinking monomers. Further, the crosslinking monomer may comprise two or more isomers of the same general structure.

In favored embodiments, the crosslinked adhesive composition comprises high shear values to stainless steel or orange peel drywall, i.e. greater than 10,000 minutes at 70° C., as determined according to the test methods described in the examples. The crosslinked pressure sensitive adhesive can exhibit a variety of peel adhesion values depending on the intended end use. In some embodiments, the 180° degree peel adhesion to stainless steel is least 15 N/dm. In other embodiments, the 180° degree peel adhesion to stainless steel is least 20, 25, 30, 35, 40, 45, 50, 55, 60, 65, 70, or 75 N/dm. The 180° degree peel adhesion to stainless steel is typically no greater than 150 or 100 N/dm. Such peel adhesive values are also attainable when adhered to other substrates.

The crosslinking monomer does not form corrosive by-products and has good color stability.

The (e.g. pressure sensitive) adhesive may optionally comprise another crosslinker in addition to the crosslinker comprising at least two (meth)allyl groups. In some embodiments, the (e.g. pressure sensitive) adhesive comprises a multifunctional (meth)acrylate. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof.

Generally the multifunctional (meth)acrylate is not part of the original monomer mixture, but added subsequently after the formation of the (meth)acrylic polymer. If used, the multifunctional (meth)acrylate is typically used in an amount of at least 0.01, 0.02, 0.03, 0.04, or 0.05 up to 1, 2, 3, 4, or 5 parts by weight, relative to 100 parts by weight of the total monomer content.

In some embodiments, the (e.g. pressure sensitive) adhesive comprises predominantly (greater than 50%, 60%, 70%, 80%, or 90% of the total crosslinks) or exclusively crosslinks from the crosslinking monomer that comprises at least two (meth)allyl groups. In such embodiment, the (e.g. pressure sensitive) adhesive may be free of other crosslinking compounds, particularly aziridine crosslinkers, as well as multifunctional (meth)acrylate crosslinkers, chlorinated triazine crosslinkers and melamine crosslinkers.

In some embodiments, the (meth)acrylic copolymers and adhesive composition can be polymerized by various techniques including, but not limited to, solvent polymerization, dispersion polymerization, solventless bulk polymerization, and radiation polymerization, including processes using ultraviolet light, electron beam, and gamma radiation. The monomer mixture may comprise a polymerization initiator, especially a thermal initiator or a photoinitiator of a type and in an amount effective to polymerize the comonomers.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature (e.g. about 40 to 100° C.) until the reaction is complete, typically in about 1 to 20 hours, depending upon the batch size and temperature. Examples of typical solvents include methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

Useful initiators include those that, on exposure to heat or light, generate free-radicals that initiate (co)polymerization of the monomer mixture. The initiators are typically employed at concentrations ranging from about 0.0001 to about 3.0 parts by weight, preferably from about 0.001 to about 1.0 parts by weight, and more preferably from about 0.005 to about 0.5 parts by weight of the total monomer or polymerized units.

Suitable initiators include but are not limited to those selected from the group consisting of azo compounds such as VAZO 64 (2,2′-azobis(isobutyronitrile)), VAZO 52 (2,2′-azobis(2,4-dimethylpentanenitrile)), and VAZO 67 (2,2′-azobis-(2-methylbutyronitrile)) available from E.I. du Pont de Nemours Co., peroxides such as benzoyl peroxide and lauroyl peroxide, and mixtures thereof. The preferred oil-soluble thermal initiator is (2,2′-azobis-(2-methylbutyronitrile)). When used, initiators may comprise from about 0.05 to about 1 part by weight, preferably about 0.1 to about 0.5 part by weight based on 100 parts by weight of monomer components in the pressure sensitive adhesive.

The polymers prepared from solution polymerization have pendent unsaturated groups that can be crosslinked by a variety of methods. These include addition of thermal or photo initiators followed by heat or UV exposure after coating. The polymers may also be crosslinked by exposure to electron beam or gamma irradiation.

One preferred method of preparing (meth)acrylic polymers includes partially polymerizing monomers to produce a syrup composition comprising the solute (meth)acrylic polymer and unpolymerized solvent monomer(s). The unpolymerized solvent monomer(s) typically comprises the same monomer as utilized to produce the solute (meth)acrylic polymer. If some of the monomers were consumed during the polymerization of the (meth)acrylic polymer, the unpolymerized solvent monomer(s) comprises at least some of the same monomer(s) as utilized to produce the solute (meth)acrylic polymer. Further, the same monomer(s) or other monomer(s) can be added to the syrup once the (meth)acrylic polymer has been formed. Partial polymerization provides a coatable solution of the (meth)acrylic solute polymer in one or more free-radically polymerizable solvent monomers. The partially polymerized composition is then coated on a suitable substrate and further polymerized.

In some embodiments, the crosslinking monomer is added to the monomer(s) utilized to form the (meth)acrylic polymer. Alternatively or in addition thereto, the crosslinking monomer may be added to the syrup after the (meth)acrylic polymer has been formed. One of the (meth)allyl groups of the crosslinker and other (e.g. (meth)acrylate) monomers utilized to form the (meth)acrylic polymer polymerize forming an acrylic backbone with the pendent (meth)allyl group. Without intending to be bound by theory, it is surmised that at least a portion of the carbon-carbon double bonds of the (meth)allyl group crosslink with each other during radiation curing of the syrup. Other reaction mechanisms may also occur.

The syrup method provides advantages over solvent or solution polymerization methods; the syrup method yielding higher molecular weight materials. These higher molecular weights increase the amount of chain entanglements, thus increasing cohesive strength. Also, the distance between cross-links can be greater with high molecular syrup polymer, which allows for increased wet-out onto a surface.

Polymerization of the (meth)acrylate solvent monomers can be accomplished by exposing the syrup composition to energy in the presence of a photoinitiator. Energy activated initiators may be unnecessary where, for example, ionizing radiation is used to initiate polymerization. Typically, a photoinitiator can be employed in a concentration of at least 0.0001 part by weight, preferably at least 0.001 part by weight, and more preferably at least 0.005 part by weight, relative to 100 parts by weight of the syrup.

A preferred method of preparation of the syrup composition is photoinitiated free radical polymerization. Advantages of the photopolymerization method are that 1) heating the monomer solution is unnecessary and 2) photoinitiation is stopped completely when the activating light source is turned off. Polymerization to achieve a coatable viscosity may be conducted such that the conversion of monomers to polymer is up to about 30%. Polymerization can be terminated when the desired conversion and viscosity have been achieved by removing the light source and by bubbling air (oxygen) into the solution to quench propagating free radicals. The solute polymer(s) may be prepared conventionally in a non-monomeric solvent and advanced to high conversion (degree of polymerization). When solvent (monomeric or non-monomeric) is used, the solvent may be removed (for example by vacuum distillation) either before or after formation of the syrup composition. While an acceptable method, this procedure involving a highly converted functional polymer is not preferred because an additional solvent removal step is required, another material may be required (a non-monomeric solvent), and dissolution of the high molecular weight, highly converted solute polymer in the monomer mixture may require a significant period of time.

The polymerization is preferably conducted in the absence of solvents such as ethyl acetate, toluene and tetrahydrofuran, which are non-reactive with the functional groups of the components of the syrup composition. Solvents influence the rate of incorporation of different monomers in the polymer chain and generally lead to lower molecular weights as the polymers gel or precipitate from solution. Thus, the (e.g. pressure sensitive) adhesive can be free of unpolymerizable organic solvent.

Useful photoinitiators include benzoin ethers such as benzoin methyl ether and benzoin isopropyl ether; substituted acetophenones such as 2,2-dimethoxy-2-phenylacetophenone photoinitiator, available the trade name IRGACURE 651 or ESACURE KB-1 photoinitiator (Sartomer Co., West Chester, Pa.), and dimethylhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

Preferred photoinitiators are photoactive compounds that undergo a Norrish I cleavage to generate free radicals that can initiate by addition to the acrylic double bonds. The photoinitiator can be added to the mixture to be coated after the polymer has been formed, i.e., photoinitiator can be added to the syrup composition. Such polymerizable photoinitiators are described, for example, in U.S. Pat. Nos. 5,902,836 and 5,506,279 (Gaddam et al.).

Such photoinitiators preferably are present in an amount of from 0.1 to 1.0 part by weight, relative to 100 parts by weight of the total syrup content. Accordingly, relatively thick coatings can be achieved when the extinction coefficient of the photoinitiator is low.

The syrup composition and the photoinitiator may be irradiated with activating UV radiation to polymerize the monomer component(s). UV light sources can be of two types: 1) relatively low light intensity sources such as blacklights, which provide generally 10 mW/cm² or less (as measured in accordance with procedures approved by the United States National Institute of Standards and Technology as, for example, with a UVIMAP UM 365 L-S radiometer manufactured by Electronic Instrumentation & Technology, Inc., in Sterling, Va.) over a wavelength range of 280 to 400 nanometers; and 2) relatively high light intensity sources such as medium pressure mercury lamps which provide intensities generally greater than 10 mW/cm², preferably 15 to 450 mW/cm². Where actinic radiation is used to fully or partially polymerize the syrup composition, high intensities and short exposure times are preferred. For example, an intensity of 600 mW/cm² and an exposure time of about 1 second may be used successfully. Intensities can range from 0.1 to 150 mW/cm², preferably from 0.5 to 100 mW/cm², and more preferably from 0.5 to 50 mW/cm².

The degree of conversion can be monitored during the irradiation by measuring the index of refraction of the polymerizing medium as previously described. Useful coating viscosities are achieved with conversions (i.e., the percentage of available monomer polymerized) in the range of up to 30%, preferably 2% to 20%, more preferably from 5% to 15%, and most preferably from 7% to 12%. The molecular weight (weight average) of the solute polymer(s) is typically at least 100,000; 250,000; 500,000 g/mole or greater.

When preparing (meth)acrylic polymers described herein, it is expedient for the photoinitiated polymerization reactions to proceed to virtual completion, i.e., depletion of the monomeric components, at temperatures less than 70° C. (preferably at 50° C. or less) with reaction times less than 24 hours, preferably less than 12 hours, and more preferably less than 6 hours. These temperature ranges and reaction rates obviate the need for free radical polymerization inhibitors, which are often added to acrylic systems to stabilize against undesired, premature polymerization and gelation. Furthermore, the addition of inhibitors adds extraneous material that will remain with the system and inhibit the desired polymerization of the syrup composition and formation of the crosslinked pressure-sensitive adhesives.

Free radical polymerization inhibitors are often required at processing temperatures of 70° C. and higher for reaction periods of more than 6 to 10 hours.

The pressure sensitive adhesives may optionally contain one or more conventional additives. Preferred additives include tackifiers, plasticizers, dyes, antioxidants, UV stabilizers, and (e.g. inorganic) fillers such as (e.g. fumed) silica and glass bubbles.

In some embodiments, the pressure sensitive adhesive comprises fumed silica. Fumed silica, also known as pyrogenic silica, is made from flame pyrolysis of silicon tetrachloride or from quartz sand vaporized in a 3000° C. electric arc. Fumed silica consists of microscopic droplets of amorphous silica fused into (e.g. branched) three-dimensional primary particles that aggregate into larger particles. Since the aggregates do not typically break down, the average particle size of fumed silica is the average particle size of the aggregates. Fumed silica is commercially available from various global producers including Evonik, under the trade designation “Aerosil”; Cabot under the trade designation “Cab-O-Sil”, and Wacker Chemie-Dow Corning. The BET surface area of suitable fumed silica is typically at least 50 m²/g, or 75 m²/g, or 100 m²/g. In some embodiments, the BET surface area of the fumed silica is no greater than 400 m²/g, or 350 m²/g, or 300 m²/g, or 275 m²/g, or 250 m²/g. The fumed silica aggregates preferably comprise silica having a primary particle size no greater than 20 nm or 15 nm. The aggregate particle size is substantially larger than the primary particle size and is typically at least 100 nm or greater.

The concentration of (e.g. fumed) silica can vary. In some embodiments, such as for conformable pressure sensitive adhesives, the adhesive comprises at least 0.5, 1.0, 1.1, 1.2, 1.3, 1.4, or 1.5 wt-% of (e.g. fumed) silica and in some embodiments no greater than 5, 4, 3, or 2 wt-%. In other embodiments, the adhesive comprises at least 5, 6, 7, 8, 9, or 10 wt-% of (e.g. fumed) silica and typically no greater than 20, 19, 18, 17, 16, or 15 wt-% of (e.g. fumed) silica.

In some embodiments, the pressure sensitive adhesive comprises glass bubbles. Suitable glass bubbles generally have a density ranging from about 0.125 to about 0.35 g/cc. In some embodiments, the glass bubbles have a density less than 0.30, 0.25, or 0.20 g/cc. Glass bubbles generally have a distribution of particles sizes. In typical embodiments, 90% of the glass bubbles have a particle size (by volume) of at least 75 microns and no greater than 115 microns. In some embodiments, 90% of the glass bubbles have a particle size (by volume) of at least 80, 85, 90, or 95 microns. In some embodiments, the glass bubbles have a crush strength of at least 250 psi and no greater than 1000, 750, or 500 psi. Glass bubbles are commercially available from various sources including 3M, St. Paul, Minn.

The concentration of glass bubbles can vary. In some embodiments, the adhesive comprises at least 1, 2, 3, 4 or 5 wt-% of glass bubbles and typically no greater than 20, 15, or 10 wt-% of glass bubbles.

The inclusion of glass bubbles can reduce the density of the adhesive. Another way of reducing the density of the adhesive is by incorporation of air or other gasses into the adhesive composition. For example the (e.g. syrup) adhesive composition can be transferred to a frother as described for examples in U.S. Pat. No. 4,415,615; incorporated herein by reference. While feeding nitrogen gas into the frother, the frothed syrup can be delivered to the nip of a roll coater between a pair of transparent, (e.g. biaxially-oriented polyethylene terephthalate) films. A silicone or fluorochemical surfactant is included in the froathed syrup. Various surfactants are known including copolymer surfactants described in U.S. Pat. No. 6,852,781.

In some embodiments no tackifier is used. When tackifiers are used, the concentration can range from 5 or 10 wt-% to 40, 45, 50, 55, or 60 wt-% of the (e.g. cured) adhesive composition.

Various types of tackifiers include phenol modified terpenes and rosin esters such as glycerol esters of rosin and pentaerythritol esters of rosin that are available under the trade designations “Nuroz”, “Nutac” (Newport Industries), “Permalyn”, “Staybelite”, “Foral” (Eastman). Also available are hydrocarbon resin tackifiers that typically come from C5 and C9 monomers by products of naphtha cracking and are available under the trade names “Piccotac”, “Eastotac”, “Regalrez”, “Regalite” (Eastman), “Arkon” (Arakawa), “Norsolene”, “Wingtack” (Cray Valley), “Nevtack”, LX (Neville Chemical Co.), “Hikotac”, “Hikorez” (Kolon Chemical), “Novares” (Rutgers Nev.), “Quintone”(Zeon), “Escorez” (Exxonmobile Chemical), “Nures”, and “H-Rez” (Newport Industries). Of these, glycerol esters of rosin and pentaerythritol esters of rosin, such as available under the trade designations “Nuroz”, “Nutac”, and “Foral” are considered biobased materials.

Depending on the kinds and amount of components, the pressure sensitive adhesive can be formulated to have a wide variety of properties for various end uses.

In one specific embodiment, the adhesive composition and thickness is chosen to provide a synergistic combination of properties. In this embodiment, the adhesive can be characterized as having any one or combination of attributes including being conformable, cleanly removable, reusable, reactivatible, and exhibiting good adhesion to rough surfaces.

Thus, in some embodiments, the PSA is conformable. The conformability of an adhesive can be characterized using various techniques such as dynamic mechanical analysis (as determined by the test method described in the examples) that can be utilized to determine that shear loss modulus (G″), the shear storage modulus (G′), and tan delta, defined as the ratio of the shear loss modulus (G″) to the shear storage modulus (G′). As used herein “conformable” refers to the (e.g. first) adhesive exhibiting a tan delta of at least 0.4 or greater at 25° C. and 1 hertz. In some embodiments, the (e.g. first) adhesive has tan delta of at least 0.45, 0.50, 0.55, 0.65, or 0.70 at 25° C. and 1 hertz. The tan delta at 25° C. and 1 hertz of the (e.g. first) adhesive is typically no greater than 0.80 or 1.0. In some embodiments, the tan delta of the (e.g. first) adhesive is no greater than 1.0 at 1 hertz and temperatures of 40° C., 60° C., 80° C., 100° C. and 120° C. In some embodiments, the first adhesive layer has tan delta of at least 0.4 or greater at 1 hertz and temperatures of 40° C., 60° C., 80° C., 100° C. and 120° C.

The PSA and adhesive coated articles can exhibit good adhesion to both smooth and rough surfaces. Various rough surfaces are known including for example textured drywall, such as “knock down” and “orange peel”; cinder block, rough (e.g. Brazilian) tile and textured cement. Smooth surfaces, such as stainless steel, glass, and polypropylene have an average surface roughness (Ra) as can be measured by optical inferometry of less than 100 nanometer; whereas rough surfaces have an average surface roughness greater than 1 micron (1000 nanometers), 5 microns, or 10 microns.

Surfaces with a roughness in excess of 5 or 10 microns can be measured with stylus profilometry. Standard (untextured) drywall has an average surface roughness (Ra), of about 10-20 microns and a maximum peak height (Rt using Veeco's Vison software) of 150 to 200 microns. Orange peel and knockdown drywall have an average surface roughness (Ra) greater than 20, 25, 30, 35, 40, or 45 microns and a maximum peak height (Rt) greater than 200, 250, 300, 350, or 400 microns. Orange peel drywall can have an average surface roughness (Ra) of about 50-75 microns and a maximum peak height (Rt) of 450-650 microns. Knock down drywall can have an average surface roughness (Ra) greater than 75, 80, or 85 microns, such as ranging from 90-120 microns and a maximum peak height (Rt) of 650-850 microns. In typical embodiments, Ra is no greater than 200, 175, or 150 microns and Rt is no greater than 1500, 1250, or 1000 microns. Cinder block and Brazilian tile typically have a similar average surface roughness (Ra) as orange peel drywall.

Although many conformable adhesives exhibit good initial adhesion to a rough surface, the PSA and articles described herein can exhibit a shear (with a mass of 250 g) to orange peel dry wall of at least 500 minutes. In some embodiments, the PSA and articles can exhibit a shear (with a mass of 250 g) to orange peel dry wall of at least 1000, 2000, 3000, 4000, 5000, 6000, 7000, 8000, 9000 or 10,000 minutes.

The PSA and adhesive coated articles can be cleanly removable from paper. By “cleanly removable from paper” it is meant that the paper does not tear and the paper does not have any staining or adhesive residue after removal of the adhesive from the paper when tested (according to Test Method 3 set forth in the examples). The 90° peel values to paper (according to Test Method 3, set forth in the examples) is typically at least 25 and no greater than 200 or 175 N/dm. In some embodiments, the 90° peel value to paper no greater than 50, 45, or 40 N/dm.

The PSA and adhesive coated articles can be reusable. By reuseable it is meant that PSA and/or adhesive coated article can repeatedly be removed and readhered to paper at least 1, 2, 3, 4, or 5 times. In some embodiments, it can be readhered to paper at least 5, 10, 15, or 20 times while maintaining at least 80%, 85%, or 90% of the initial peel adhesion (according to the “Reusability” test further described in the examples).

Further, in some embodiments, the adhesive can be reactivatible, i.e. contaminants can be removed by cleaning the adhesive layer(s) with soap and water, such as by the test methods described in WO 96/31564; incorporated herein by reference.

The adhesives of the present invention may be coated upon a variety of flexible and inflexible backing materials using conventional coating techniques to produce adhesive-coated materials. Flexible substrates are defined herein as any material which is conventionally utilized as a tape backing or may be of any other flexible material. Examples include, but are not limited to plastic films such as polypropylene, polyethylene, polyvinyl chloride, polyester (polyethylene terephthalate), polycarbonate, polymethyl(meth)acrylate (PMMA), cellulose acetate, cellulose triacetate, and ethyl cellulose. Foam backings may be used. In some embodiments, the backing is comprised of a bio-based material such as polylactic acid (PLA).

The adhesive can also be provided in the form of a pressure-sensitive adhesive transfer tape in which at least one layer of the adhesive is disposed on a release liner for application to a permanent substrate at a later time. The adhesive can also be provided as a single coated or double coated tape in which the adhesive is disposed on a permanent backing.

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metalized polymer films, or ceramic sheet materials may take the form of any article conventionally known to be utilized with pressure-sensitive adhesive compositions such as labels, tapes, signs, covers, marking indicia, and the like.

Backings can be made from plastics (e.g., polypropylene, including biaxially oriented polypropylene, vinyl, polyethylene, polyester such as polyethylene terephthalate), nonwovens (e.g., papers, cloths, nonwoven scrims), metal foils, foams (e.g., polyacrylic, polyethylene, polyurethane, neoprene), and the like. Foams are commercially available from various suppliers such as 3M Co., Voltek, Sekisui, and others. The foam may be formed as a coextruded sheet with the adhesive on one or both sides of the foam, or the adhesive may be laminated to it. When the adhesive is laminated to a foam, it may be desirable to treat the surface to improve the adhesion of the adhesive to the foam or to any of the other types of backings. Such treatments are typically selected based on the nature of the materials of the adhesive and of the foam or backing and include primers and surface modifications (e.g., corona treatment, surface abrasion). Suitable primers include for example those described in EP 372756, U.S. Pat. No. 5,534,391, U.S. Pat. No. 6,893,731, WO2011/068754, and WO2011/38448.

In some embodiments, the backing material is a transparent film having a transmission of visible light of at least 90 percent. The transparent film may further comprise a graphic. In this embodiment, the adhesive may also be transparent.

The above-described compositions can be coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. The composition may also be coated from the melt. These various methods of coating allow the compositions to be placed on the substrate at variable thicknesses thus allowing a wider range of use of the compositions. Coating thicknesses may vary as previously described. The syrup composition may be of any desirable concentration for subsequent coating, but is typically 5 to 20 wt-% polymer solids in monomer. The desired concentration may be achieved by further dilution of the coating composition, or by partial drying. Coating thicknesses may vary from about 25 to 1500 microns (dry thickness). In typical embodiments, the coating thickness ranges from about 50 to 250 microns. When the multilayer PSA or article is intended to be bonded to a rough surface, the thickness of the adhesive layer typically ranges from the average roughness (Ra) to slightly greater than the maximum peak height (Rt).

For a single-sided tape, the side of the backing surface opposite that where the adhesive is disposed is typically coated with a suitable release material. Release materials are known and include materials such as, for example, silicone, polyethylene, polycarbamate, polyacrylics, and the like. For double coated tapes, another layer of adhesive is disposed on the backing surface opposite that where the adhesive of the invention is disposed. The other layer of adhesive can be different from the adhesive of the invention, e.g., a conventional acrylic PSA, or it can be the same adhesive as the invention, with the same or a different formulation. Double coated tapes are typically carried on a release liner. Additional tape constructions include those described in U.S. Pat. No. 5,602,221 (Bennett et al.), incorporated herein by reference.

Objects and advantages of this invention are further illustrated by the following examples. The particular materials and amounts, as well as other conditions and details, recited in these examples should not be used to unduly limit this invention.

### EXAMPLES

TABLE 1
Glossary of Materials

| Material | Description |
|---|---|
| 2-Octyl Acrylate (2OA) | Prepared according to Preparatory Example |
| | 1 of U.S. Pat. No. 7,385,020. |
| Iso-octyl Acrylate (IOA) | Obtained from 3M Company (St. Paul, |
| | MN, USA) |
| Acrylic Acid (AA) | Obtained from BASF Corporation (Florham |
| | Park, NJ, USA) |
| Irgacure 651 (651) | Obtained from BASF Corporation (Florham |
| | Park, NJ, USA) |
| Irgacure 184 (184) | Obtained from BASF Corporation (Florham |
| | Park, NJ, USA) |
| Diallyl Adipate (DAA) | Obtained from Alfa Aesar (Tokyo, |
| | Japan) |
| Terephtalic Acid | Obtained from TCI Chemicals (Tokyo, |
| Diallyl Ester (TADE) | Japan) |
| Triallyl Isocyanurate | Obtained from TCI Chemicals (Tokyo, |
| (TAIC) | Japan) |
| Triallyl Cyanurate (TAC) | Obtained Evonik Industries (Hanau, |
| | Germany) |
| Pentaerythritol Allyl | Obtained from Sigma-Aldrich (St Louis, |
| Ether (PEAE) | MO, USA) |
| Trimethylol Propane | Obtained from Sigma-Aldrich (St Louis, |
| Diallyl Ether (TMPDE) | MO, USA) |
| Diallyl Maleate (DAM) | Obtained from TCI Chemicals (Tokyo, |
| | Japan) |
| Diallyl Sebacate (DAS) | Can be obtained from 3B Scientific |
| | Corporation (Libertyville, IL) |
| 1,6-hexane diol | Obtained from Cytec Industries, Inc. |
| diacrylate (HDDA) | (Woodland Park, NJ, USA) |
| Diallyl dimethyl | Obtained from TCI Chemicals (Tokyo, |
| silane (DADMS) | Japan) |
| Diallyl carbonate (DAC) | Obtained from Sigma-Aldrich (St Louis, |
| | MO, USA) |
| 1,9-decadiene (DD) | Obtained from Sigma-Aldrich (St Louis, |
| | MO, USA) |
| Divinyl benzene (DVB) | Obtained from Alfa Aesar (Ward Hill, |
| | MA, USA) |
| Triallyl amine (TAA) | Obtained from Alfa Aesar (Ward Hill, |
| | MA, USA) |
| Hostaphan 3SAB Primed | Obtained from Mitsubishi Polyester |
| Polyethylene terephthalate | Films, Inc. (Greer, SC, USA) |
| Film (PET) | |
| T10 Release Liner (T10) | Obtained from Solutia, Inc. (St Louis, |
| | MO, USA) |
| T50 Release Liner (T50) | Obtained from Solutia, Inc. (St Louis, |
| | MO, USA) |

### Test Method 1: Shear Strength Test on Stainless Steel

The adhesive films described were cut into strips 0.5 inch (1.27 cm) in width and adhered by their adhesive to flat, rigid stainless steel plates with exactly 1 inch (2.54 cm) length of each adhesive film strip in contact with the plate to which it was adhered. A weight of 2 kilograms (4.5 pounds) was rolled over the adhered portion. Each of the resulting plates with the adhered film strip was equilibrated at room temperature for 15 minutes. Afterwards, the samples was transferred to a 70° C. oven, in which a 500 g weight was hung from the free end of the adhered film strip with the panel tilted 2° from the vertical to insure against any peeling forces. The time (in minutes) at which the weight fell, as a result of the adhesive film strip releasing from the plate, was recorded. The test was discontinued at 10,000 minutes if there was no failure. In the Tables, this is designated as 10,000+ minutes. Three specimens of each tape (adhesive film strip) were tested and the shear strength test times were averaged to obtain the reported shear holding power time values.

### Test Method 2: Peel Adhesion Test on Stainless Steel

Peel adhesion was the force required to remove an adhesive-coated test specimen from a test panel measured at a specific angle and rate of removal. In the Examples, this force is expressed in ounces per inch width of coated sheet. The following procedure was used:

(1) A test specimen 0.5″ (1.27 cm) wide was applied to a horizontally positioned clean stainless steel (SS) test plate. A 2.2 kg rubber roller was used to press a 4″ (10.16 cm) length of specimen into firm contact with the glass surface.

(2) The free end of the specimen was doubled back, nearly touching itself, so the angle of removal was 180°. The free end was attached to the adhesion tester scale.

(3) The stainless steel (SS) test plate was clamped in the jaws of a tensile testing machine which was capable of moving the plate away from the scale at a constant rate of 12″ (30.48 cm) per minute.

(4) The scale reading in ounces was recorded as the tape is peeled from the glass surface. The resulting peel adhesion was converted from ounces/0.5 inch to ounces/inch to Newtons/decimeter (N/dm) to yield the final peel adhesion values listed.

### Test Method 3: 90°-Angle Peel Adhesion Test on Paper Surfaces

Cut out a 1 in (2.54 cm) wide and >3 in (7.62 cm) length specimen in the machine direction from the test sample. Remove the liner from one side of the adhesive and place it on an aluminum panel (2″×5″ (5.08 cm×12.7 cm)). Remove liner from other side of adhesive and place it on a strip of copy paper* (1 inch (2.54 cm) wide and >5 inches (7.62 cm)) using light finger pressure. Roll once in each direction with the standard FINAT test roller 4.5 lb (2 kg) at a speed of approx. at 12″/min. [305 mm]/min.). After applying the strips to the test panels, allow the panels samples to dwell at constant temperature and humidity (25° C./50% RH) room for 10 minutes before using an Instron tester. Fix the test panel and strip into the horizontal support. Set the machine at 305 mm per minute jaw separation rate. Test results were measured in gram force per inch and converted to Newtons per dm. The peel values are the average of three 90° angle peel measurements. *The copy paper utilized is available from Boise™ under the trade designation “X-9” (92 brightness, 24 lb. (90 gsm/12M), 500 sheets, 8.5×11(216 mm×279 mm)).

All the examples tested were cleanly removable from the copy paper unless specified otherwise, meaning that the paper did not tear and also did not have any staining or reside after removal of the adhesive.

Reuseablility can be tested by repeating this test method with a fresh piece of paper each time.

### Test Method 4: Static Shear Test on Dry Wall

### Preparation of Drywall for Testing

The substrates employed were standard smooth drywall obtained from Home Depot (Woodbury, Minn.) and orange-peel drywall was prepared by IUPAT (International Union of Painters and Allied Trades, 3205 Country Drive, Little Canada, Minn.). Drywall was primed using paint roller with Sherwin-Williams Pro-Mar 200. Surfaces were dried for a minimum of 4 hours at ambient conditions before applying next coat of paint. White paint (Valspar Signature, Hi-def Advanced Color, Eggshell Interior, #221399, Ultra White/Base A) was applied to primed drywall using a new paint roller and allowed to dry at ambient conditions until tackless before applying a second coat of the same color. Final painted drywall was dried overnight at ambient conditions and then placed into a 120° C. oven for 1 week. Samples were removed from oven and cut into desired dimensions using draw knife. Samples were dusted off using Kim wipes, tissue, paper towels, or air (no cleaning with solvents) to remove dust left over from cutting before use in testing.

A standard static shear test was performed at elevated temperature according to Pressure Sensitive Tape Council (Chicago, Ill./USA) PSTC-107 (procedure G). The test was performed at 70° F./50% Relative Humidity as called for by the method. The sample area of adhesive bonded to the prepared drywall surface was 2.54 cm in the vertical direction by 2.54 cm in the width direction (rather than 1.27 cm by 1.27 cm as called for by the method). Then a 6.8 kg weight was placed on top of sample for 1 minute. After a dwell time of 60 seconds, the test specimen was hung in the shear stand at desired temperature and loaded immediately with a 250 g weight. The time to failure for the adhesive bond was recorded in minutes. The test was discontinued at 10,000 minutes and samples that passed the test are reported as 10,000+ minutes.

### Test Method 5: 90° Peel Adhesion Test [ASTM D 3330/D 3330M-04]

Stainless steel (SS) substrates were cleaned as noted above. Two 1.0 inch (2.54 cm) by 3.0 inch (7.62 cm) strips of adhesive were laminated to a 5 mil (127 micrometers) aluminum foil backing for testing and were adhered to a stainless steel substrate (cleaned as described above) by rolling twice in each direction with a 6.8 kg roller onto the tape at 12 inches per minute (305 mm/min). The force required to peel the tape at 90° was measured after a 24 hour dwell at 25° C./50% humidity on an Instron (model number 4465). The measurements for the two tape samples were in pound-force per inch with a platen speed of 12 inches per minute (about 305 mm/min). The results were averaged and recorded.

### Test Method 6: Shear Strength Test [ASTM D-3654/D 3654M 06, PSTC-107]-FOR SS 15

A stainless steel (SS) backing was adhered to a stainless steel (SS) substrate (cleaned as described above) and cut down to leave a 1.0 inch (2.54 cm) by 0.5 inch (1.27 cm) square for 158° F. (70° C.) temperature shear testing. A weight of was 1 kg was placed on the sample for 15 minutes. A 500 g load was attached to the tape sample for testing. Each sample was suspended until failure and/or test terminated. The time to failure was recorded. Samples were run in triplicate and averaged.

### Test Method 6: Dynamic Mechanical Analysis

Some examples were analyzed by Dynamic Mechanical Analysis (DMA) using a Discovery Hybrid parallel plate rheometer (TA Instruments) to characterize the physical properties of each sample as a function of temperature. Rheology samples were prepared by punching out a section of the PSA with an 8 mm circular die, removing it from the release liners, centering it between 8 mm diameter parallel plates of the rheometer, and compressing until the edges of the sample were uniform with the edges of the top and bottom plates. The furnace doors that surround the parallel plates and shafts of the rheometer were shut and the temperature was equilibrated at 20° C. and held for 1 minute. The temperature was then ramped from 20° C. to 125 or 130° C. at 3° C./min while the parallel plates were oscillated at an angular frequency of 1 Hertz and a constant strain of 5 percent.

### Preparatory Example 1

### Di-allyl isophorone urethane, DAU

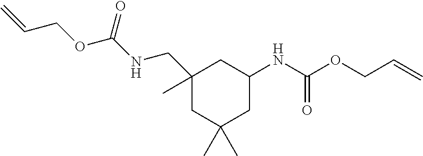 [SMILES: C=CCOC(=O)NCC1(C)CC(NC(=O)OCC=C)CC(C)(C)C1]

A mixture of allyl alcohol (7.84 g, 0.13 mol, Aldrich Chemical Company, Milwaukee, Wis.), isophorone diisocyanate (15.00 g, 67 mmol, TCI America, Portland, Oreg.), and dibutyltin dilaurate (30 mg, 0.05 mmol, Alfa Aesar, Ward Hill, Mass.) was mixed in a jar while cooling in a cold water bath. After 30 minutes, the mixture was placed at room temperature for 7 hours. A thick, colorless liquid was obtained.

### Preparatory Example 2

### Dimethallyl Adipate, DMA

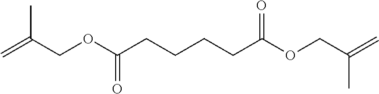 [SMILES: C=C(C)COC(=O)CCCCC(=O)OCC(=C)C]

A mixture of 2-methyl propenol (44.86 g, 0.62 mol, Aldrich), triethylamine (27.64 g, 0.27 mol, EMD Chemicals, Gibbstown, N.J.) and methylene chloride (250 mL, VWR, West Chester, Pa.) was cooled in an ice bath. Adipoyl chloride (50.48 g, 0.28 mol, Alfa Aesar) was added dropwise over one hour. The mixture was then stirred for one hour and concentrated under vacuum. Hexane (200 mL, EMD Chemicals) and ethyl acetate (50 mL, VWR) were added and the mixture was filtered. The filtrate was washed with 0.1 M HCl and saturated aqueous sodium bicarbonate then dried over magnesium sulfate. The solvent was removed under vacuum and phenothiazine (20 mg, TCI America) was added. The mixture was distilled under vacuum (107-112° C. @0.2 mmHg) to give the product as a colorless liquid (47.28 g).

### Preparatory Example 3

### Di-undecenyl isophorone urethane, DUU

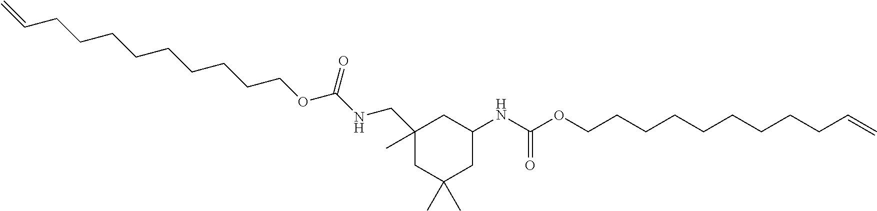 [SMILES: C=CCCCCCCCCCOC(=O)NCC1(C)CC(NC(=O)OCCCCCCCCCC=C)CC(C)(C)C1]

A mixture of 10-undecen-1-ol (30.64 g, 0.18 mol, Alfa Aesar), isophorone diisocyanate (20.00 g, 90 mmol), and dibutyltin dilaurate (60 mg, 0.10 mmol) was mixed in a jar while cooling in a cold water bath. After 30 minutes, the jar was placed in an oven at 50° C. for 12 hours. A thick, colorless liquid was obtained.

### Preparatory Example 4

### Undecenyl adipate, UDAd

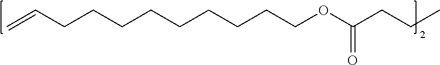

A mixture of 10-undecen-1-ol (46.52 g, 0.27 mol), triethylamine (27.62 g, 0.27 mol) and methylene chloride (250 mL) was cooled in an ice bath. Adipoyl chloride (25.00 g, 0.14 mol) was added dropwise over two hours. The mixture was then stirred for two hours then filtered. The filtrate was then concentrated under vacuum. Ethyl acetate (100 mL) was added and the mixture was washed with saturated aqueous sodium bicarbonate then concentrated under vacuum. The crude product was filtered through silica gel (150 g) and eluted with hexane. The filtrate was concentrated under vacuum. The resulting oil was heated to 120° C. under vacuum (@0.15 mmHg) to remove residual 10-undecen-1-ol. The remaining liquid was cooled to give the product as a red oil (31.70 g).

### Preparatory Example 5

### 1,4-butanediol di-undecenylate, BDDU

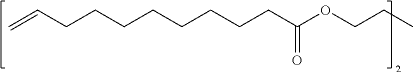

A mixture of 1,4-butanediol (6.38 g, 71 mmol, Alfa Aesar), triethylamine (15.16 g, 0.15 mol), and methylene chloride (150 mL) was cooled in an ice bath. Undecenyl chloride (30.00 g, 0.15 mol, Aldrich) was added dropwise over one hour. The mixture was stirred for 17 hours and heptane (50 mL) was added. The mixture was filtered and concentrated under vacuum. Ethyl acetate (150 mL) was added and the mixture was washed with 1.0 M HCl and saturated aqueous sodium bicarbonate then dried over magnesium sulfate. The solvent was removed under vacuum to give a brown oil (35.23 g). A portion of the crude product (5.00 g) was purified by column chromatography over silica gel using a mixture of ethyl acetate in hexane (15 wt % ethyl acetate) to give the product as a colorless oil (3.62 g).

### Preparatory Example 6

### Bis(allyloxy)benzene, BAOB

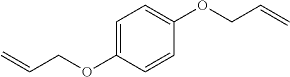

A mixture of hydroquinone (80.00 g, 0.73 mol, Aldrich), allyl bromide (237.32 g, 1.96 mol, Alfa Aesar), potassium carbonate (276.42 g, 2.0 mol), 1,4,7,10,13,16-hexaoxacyclooctadecane (18-crown-6, 1.50 g, 5.7 mmol, Aldrich), and acetone (1800 mL) was stirred at 50° C. for four hours. The mixture was cooled, filtered, and concentrated under vacuum. Ethyl acetate (500 mL) was added to the residue and the mixture was washed with 1.0 M sodium hydroxide. The solvent was removed under vacuum to give a crude oil. The oil was dissolved in hexane (100 mL) and the mixture was filtered through a column of silica gel (200 g). The filtrate was concentrated under vacuum to give the product (1,4-bis(allyloxy)benzene, 94.91 g) as a yellow oil which slowly crystallized.

### Preparatory Example 7

### Bisphenol A diallyl ether, BPADE

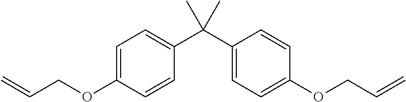 [SMILES: C=CCOc1ccc(C(C)(C)c2ccc(OCC=C)cc2)cc1]

A mixture of bisphenol A (16.78 g, 74 mmol, Aldrich), allyl bromide (24.00 g, 0.20 mol), potassium carbonate (30.00 g, 0.22 mol), 1,4,7,10,13,16-hexaoxacyclooctadecane (18-crown-6, 0.10 g, 0.38 mmol), and acetone (250 mL) was heated to 50° C. for 24 hours. The mixture was cooled, filtered, and concentrated under vacuum. The crude product was purified by column chromatography over silica gel using a mixture of 10 wt % ethyl acetate in hexane to give the product (bisphenol A diallyl ether, 15.88 g) as a colorless oil.

### Examples 1-61 and Comparative Examples C1-C2

Examples 1-31 were made by charging a 8 oz jar with 1) 90 g of 2OA, 2) 10 g of AA, 3) 0.04 g of 651, and 4) a quantity of crosslinker as shown in Table 2. The monomer mixture was purged with nitrogen for 2-5 minutes then exposed to low intensity ultraviolet radiation until a coatable prepolymer syrup was prepared. An additional 0.16 g of 651 was then added. The pre-adhesive formulations were then coated between T10 and T50 release liners at 5 mil (127 micrometer) thickness and cured by exposure to UVA light (See table 2 for dose) over 10 minutes. The PSA was then laminated to a primed PET film for adhesive testing.

Examples 32-61, and C1-C2 were made as above except that 1) 45 g of 2OA, 2) 5 g of AA, 3) 0.02 g of 651 and 4) a quantity of crosslinker as shown in Table 2 were added to the initial solution and 0.08 g of 651 was added to the prepolymer syrup.

### Example 62

Example 62 was made by charging a quart jar with 1) 281 g of 2OA, 2) 19.5 g of AA, 3) 0.2 g of Irgacure 184 (0.04), and 4) a quantity of DAA as shown in Table 2. The monomer mixture was purged with nitrogen for 5-10 minutes then exposed to low intensity ultraviolet radiation until a coatable prepolymer syrup was prepared. An additional 1.05 g (0.16 phr) of the photoinitiator and 30 g of Foral 85LB were then added. The pre-adhesive formulations were then coated onto release liner at 2 mil thickness and cured by UVA and UVC light as shown in Table 2 over 2-3 minutes. The PSA was then laminated to a primed PET film for adhesive testing.

Examples 1-62 and C1-C2 were tested using test methods 1 and 2.

TABLE 2
Composition and Adhesive Properties of Examples 1-62
and Comparative Examples C1-C2

| | | Crosslinker | | UV A | 70° C. | Peel Adhesion |
|---|---|---|---|---|---|---|
| | | conc. | Crosslinker | Dose | Shear | to SS |
| Ex. | Crosslinker | (wt. %) | Amount (g) | (mJ/cm²) | (min) | (Oz/in, N/dm) |
| 1 | DAA | 0.5 | 0.5 | 1356 | 3,238 | 71.1, 77.8 |
| 2 | DAA | 1 | 1 | 1356 | 10,000+ | 64.3, 70.4 |
| 3 | DAA | 2 | 2 | 1356 | 10,000+ | 56.8, 62.2 |
| 4 | DAA | 4 | 4 | 1356 | 10,000+ | 43.6, 47.7 |
| 5 | TAIC | 0.5 | 0.5 | 1269 | 10,000+ | 76.9, 84.2 |
| 6 | TAIC | 1 | 1 | 1269 | 10,000+ | 68.5, 75.0 |
| 7 | TAIC | 2 | 2 | 1269 | 10,000+ | 67.3, 73.7 |
| 8 | TAIC | 4 | 4 | 1269 | 10,000+ | 56.6, 62.0 |
| 9 | TMPDE | 0.5 | 0.5 | 1791 | 10,000+ | 89.8, 98.3 |
| 10 | TMPDE | 1 | 1 | 1791 | 10,000+ | 95.5, 104.5 |
| 11 | TMPDE | 2 | 2 | 1791 | 10,000+ | 65.6, 71.8 |
| 12 | TMPDE | 4 | 4 | 1791 | 10,000+ | 56.9, 62.3 |
| 13 | TAC | 0.5 | 0.5 | 1448 | 10,000+ | 57.7, 63.2 |
| 14 | TAC | 1 | 1 | 1448 | 10,000+ | 54.9, 60.1 |
| 15 | TAC | 2 | 2 | 1448 | 10,000+ | 49.6, 54.3 |
| 16 | TAC | 4 | 4 | 1448 | 10,000+ | 38.6, 42.3 |
| 17 | PEAE | 0.5 | 0.5 | 1366 | 10,000+ | 54.2, 59.3 |
| 18 | PEAE | 1 | 1 | 1366 | 10,000+ | 54.6, 59.8 |
| 19 | PEAE | 2 | 2 | 1366 | 10,000+ | 48.7, 53.3 |
| 20 | PEAE | 4 | 4 | 1366 | 10,000+ | 38.6, 42.3 |
| 21 | DAU | 0.5 | 0.5 | 1374 | 1,695 | 64.1, 70.2 |
| 22 | DAU | 0.75 | 0.75 | 1374 | 10,000+ | 77.6, 84.9 |
| 23 | DAU | 1 | 1 | 1150 | 10,000+ | 74.4, 81.4 |
| 24 | DAU | 2 | 2 | 1150 | 10,000+ | 78.9, 86.4 |
| 25 | DMA | 0.5 | 0.5 | 1398 | 10,000+ | 73.6, 80.6 |
| 26 | DMA | 1 | 1 | 1398 | 10,000+ | 58.4, 63.9 |
| 27 | DMA | 2 | 2 | 1398 | 10,000+ | 49.9, 54.6 |
| 28 | DUU | 0.5 | 0.5 | 1296 | 10,000+ | 78.2, 85.6 |
| 29 | DUU | 1 | 1 | 1296 | 10,000+ | 77.7, 85.0 |
| 30 | DUU | 2 | 2 | 1296 | 10,000+ | 72.8, 79.7 |
| 31 | DUU | 4 | 4 | 1296 | 10,000+ | 72.1, 78.9 |
| 32 | TADE | 0.5 | 0.25 | 1218 | 3,659 | 83.9, 91.8 |
| 33 | TADE | 1 | 0.5 | 1218 | 10,000+ | 78.4, 85.8 |
| 34 | TADE | 2 | 1 | 1218 | 10,000+ | 70.3, 76.9 |
| 35 | TADE | 4 | 2 | 1218 | 10,000+ | 63.6, 69.6 |
| 36 | DAS | 0.5 | 0.25 | 1218 | 1,294 | 67.7, 74.1 |
| 37 | DAS | 1 | 0.5 | 1218 | 10,000+ | 68.1, 74.5 |
| 38 | DAS | 2 | 1 | 1218 | 10,000+ | 56.8, 62.2 |
| 39 | DAS | 4 | 2 | 1218 | 10,000+ | 50.0, 54.7 |
| 40 | UDAd | 0.5 | 0.25 | 1389 | 1,653 | 95.6, 104.6 |
| 41 | UDAd | 1 | 0.5 | 1389 | 10,000+ | 85.4, 93.5 |
| 42 | UDAd | 2 | 1 | 1389 | 10,000+ | 84.3, 92.3 |
| 43 | UDAd | 4 | 2 | 1389 | 10,000+ | 73.8, 80.8 |
| 44 | DAM | 0.5 | 0.25 | 1362 | 10,000+ | 76.0, 83.2 |
| 45 | DAM | 1 | 0.5 | 1362 | 10,000+ | 73.3, 80.2 |
| 46 | DAM | 2 | 1 | 1362 | 10,000+ | 71.6, 78.4 |
| 47 | DAM | 4 | 2 | 1362 | 10,000+ | 60.0, 65.7 |
| 48 | BPADE | 0.5 | 0.25 | 3096 | 1,684 | 95.4, 104.4 |
| 49 | BPADE | 1 | 0.5 | 3096 | 10,000+ | 83.3, 91.2 |
| 50 | BAOB | 0.5 | 0.25 | 3096 | 8,785 | 86.3, 94.5 |
| 51 | BAOB | 1 | 0.5 | 3096 | 10,000+ | 88.2, 96.5 |
| 52 | DADMS | 0.5 | 0.25 | 2102 | 10,000+ | 70.6, 77.3 |
| 53 | DADMS | 1 | 0.5 | 2102 | 10,000+ | 63.4, 69.4 |
| 54 | DAC | 0.5 | 0.25 | 2102 | 3,403 | 88.5, 96.7 |
| 55 | DAC | 1 | 0.5 | 2102 | 10,000+ | 76.4, 83.6 |
| 56 | DD | 0.5 | 0.25 | 2102 | 10,000+ | 91.2, 99.8 |
| 57 | DD | 1 | 0.5 | 2102 | 10,000+ | 52.9, 57.9 |
| 58 | BDDU | 0.5 | 0.25 | 2102 | 2,853 | 66.1, 72.4 |
| 59 | BDDU | 1 | 0.5 | 2102 | 10,000+ | 69.8, 76.4 |
| 60 | TAA | 0.5 | 0.25 | 2102 | 10,000+ | 82.4, 92.2 |
| 61 | TAA | 1 | 0.5 | 2102 | 10,000+ | 63.6, 69.6 |
| C1 | HDDA* | 0.2 | 0.1 | n.m.** | n.m.** | n.m.** |
| C2 | DVB* | 0.5 | 0.25 | n.m.** | n.m.** | n.m.** |
| 62 | DAA | 2 | 6 | 545 + | 10,000+ | 48.5, 53.1 |
| | | | | 198 UVC | | |

*Sample gelled upon attempted formation of the prepolymer syrup.
**n.m.—not measured

### Examples 63-66

Examples 63-66 were made by charging a 8 oz jar with 1) 45 g of 2OA, 2) 5 g of AA, and 3) 0.02 g of 651. The monomer mixture was purged with nitrogen for 2-5 minutes then exposed to low intensity ultraviolet radiation until a coatable prepolymer syrup was prepared. An additional 0.08 g of 651 and a quantity of crosslinker as shown in Table 3 were then added. The pre-adhesive formulations were then coated between T10 and T50 release liners at 5 mil (127 micrometer) thickness and cured by exposure to UVA light (See table 2 for dose) over 10 minutes. The PSA was then laminated to a primed PET film for adhesive testing using test methods 1 and 2. Results are shown in Table 3.

TABLE 3
Adhesive properties of Examples and Comparative Example with crosslinker added to the
prepolymer syrup and not to the initial solution.

| | | | | | | Peel |
|---|---|---|---|---|---|---|
| | | | | | | Adhesion to |
| | | Crosslinker | | UV A | 70° C. | SS |
| | | conc. | Crosslinker | Dose | Shear | (Oz/in, |
| Example | Crosslinker | (wt. %) | Amount (g) | (mJ/cm²) | (min) | N/dm) |
| 63 | DAA | 0.5 | 0.15 | 1603 | 4,125 | 72.0, 78.8 |
| 64 | DAA | 2 | 0.6 | 1603 | 10,000+ | 68.9, 75.4 |
| 65 | TMPDE | 0.5 | 0.15 | 1603 | 10,000+ | 73.4, 80.3 |
| 66 | TMPDE | 2 | 0.6 | 1603 | 10,000+ | 65.2, 71.4 |

### Examples 67-70

Examples 67-70 were prepared by charging a 500 mL jar with 300 g (100 wt. %) 2OA, 0 g (0 wt. %) of AA, 0.12 g (0.04 phr) of photoinitiator 1, and a quantity of TMPDE according to Table 4. The monomer mixtures were purged with nitrogen for 10 minutes then exposed to low intensity UV A radiation until a coatable syrup was formed, after which another 0.57 g (0.16 phr) of photoinitiator1 was added. Next, 5.1 g (1.7 phr) of trade designation HDK H15 fumed silica (Wacker Silicones) was added and the syrup was mixed with a trade designation Netzsch Model 50 Dispersator. When the fumed silica was completely dispersed, 24 g (8 phr) of glass bubbles (K15, 3M Company, St. Paul Minn.) was added and the composition was mixed thoroughly by rolling overnight.

The compositions were then coated between a release liner and a primed polyethylene terepthalate (PET) liner at a 25 mil (635 micrometers) thickness and cured by a dose of UV A light (shown in Table 4) from 350 BL light bulbs (40 watt, Osram Sylvania) to form a PSA. Adhesive properties were tested according to test methods 3 and 4 and are shown in Table 4.

TABLE 4

| | | | | | 90° Peel |
|---|---|---|---|---|---|
| | | | | 70° C. Shear | Adhesion to |
| | TMPDE | TMPDE | UV Dose | to Orange Peel | Boise copy paper |
| Ex | (g) | (phr) | (mJ/cm²) | Dry Wall (min) | (gf/in, N/dm) |
| 67 | 2.76 | 0.92 | 2664 | 1,359 | 3,518.4, 135.8 |
| 68 | 3.15 | 1.05 | 2664 | 6,329 | 2,711.2, 104.7 |
| 69 | 4.11 | 1.37 | 666 | 7,728 | 2,041.2, 78.8 |
| 70 | 5.49 | 1.83 | 2664 | 2,018 | 2,130.4, 82.2 |

### Examples 71 and 72

Example 71 was prepared by charging a 500 mL jar with 245 g (87.5 wt. %) IOA, 35 g (12.5 wt. %) of AA, 0.11 g (0.04 phr) of photoinitiator 1, and a quantity of TMPDE according to Table 5. The monomer mixture was purged with nitrogen for 10 minutes then exposed to low intensity UV A radiation until a coatable syrup was formed, after which another 0.53 g (0.16 phr) of photoinitiator1 was added. Next, 4.76 g (1.7 phr) of trade designation HDK H15 fumed silica (Wacker Silicones) was added and the syrup was mixed with a trade designation Netzsch Model 50 Dispersator. When the fumed silica was completely dispersed, 22 g (8 phr) of glass bubbles (K15, 3M Company, St. Paul Minn.) was added and the composition was mixed thoroughly by rolling overnight.

Example 72 was made in the same fashion as Example 71 except the composition of the initial monomer mixture was 252 g (90 wt. %) IOA, 28 g (10 wt. %) of AA, 0.11 g (0.04 phr) of photoinitiator 1, and a quantity of TMPDE according to Table 5.

The compositions were then coated between a release liners at a 40 mil (1000 micrometers) thickness and cured by a dose of UV A light (shown in Table 4) from 350 BL light bulbs (40 watt, Osram Sylvania) to form a PSA. Adhesive properties were tested according to test methods 5 and 6 and are shown in Table 5.

TABLE 5

| | | | | | 90° Peel |
|---|---|---|---|---|---|
| | | | | 70° C. Shear | Adhesion to |
| | TMPDE | TMPDE | UV Dose | to Stainless | Stainless Steel |
| Ex | (g) | (phr) | (mJ/cm²) | Steel (min) | (lbf/in, N/dm) |
| 71 | 2.8 | 1.0 | 1482 | 10,000+ | 26.8, 469.3 |
| 72 | 2.8 | 1.0 | 1482 | 10,000+ | 23.7, 415.1 |

TABLE 6
Weight % of components of tackified and filled PSAs

| | Low Tg | | | | | |
|---|---|---|---|---|---|---|
| | Monomer | High Tg | | | Fumed | Glass |
| | (2OA or | Monomer | Crosslinking | Tackifier | Silica | Bubbles |
| Example | IOA) wt-% | (AA) wt-% | Monomer wt-% | wt-% | wt-% | wt-% |
| 62 | 83.2 | 5.8 | DAA-1.8 | 8.9 | 0 | 0 |
| 67 | 90.2 | 0 | TMPDE-0.8 | 0 | 1.5 | 7.2 |
| 68 | 90.1 | 0 | TMPDE-0.9 | 0 | 1.5 | 7.2 |
| 69 | 89.8 | 0 | TMPDE-1.2 | 0 | 1.5 | 7.2 |
| 70 | 89.4 | 0 | TMPDE-1.6 | 0 | 1.5 | 7.2 |
| 71 | 79.1 | 11.3 | TMPDE-0.9 | 0 | 1.5 | 7.1 |
| 72 | 81.3 | 9.0 | TMPDE-0.9 | 0 | 1.5 | 7.1 |

1. A pressure sensitive adhesive composition comprising the reaction product of a syrup comprising
i) a free-radically polymerizable solvent monomer; and
ii) a solute (meth)acrylic polymer comprising polymerized units derived from one or more alkyl (meth)acrylate monomers,
wherein the syrup comprises at least one crosslinking monomer or the (meth)acrylic solute polymer comprises polymerized units derived from at least one crosslinking monomer, wherein the crosslinking monomer has the formula
(H₂C═C(R¹)(CH₂)ₓZ
wherein
R¹ is hydrogen or methyl,
Z is a heteratom or a multivalent linking group selected from the group consisting of alkylene, arylene, oxyalkylene, ester, ether, amide, amine, urethane, urea, carbonate, silane, or a combinations thereof, and x ranges from 2 to 6.

2-4. (canceled)

5. The pressure sensitive adhesive composition of claim 1 wherein the pressure sensitive adhesive comprises at least 50 wt-% of polymerized units derived from one or more alkyl (meth)acrylate monomer(s).

6. The pressure sensitive adhesive composition of claim 1 wherein the one or more alkyl (meth)acrylates comprise 6 to 20 carbon atoms.

7. The pressure sensitive adhesive composition of claim 1 wherein the pressure sensitive adhesive comprises polymerized units derived from 2-octyl (meth)acrylate.

8. The pressure sensitive adhesive composition of claim 1 wherein the pressure sensitive adhesive further comprises filler.

9. The pressure sensitive adhesive composition of claim 8 wherein the filler comprises fumed silica or glass bubbles.

10. The pressure sensitive adhesive composition of claim 1 wherein the pressure sensitive adhesive composition further comprises a tackifier.

11. The pressure sensitive adhesive composition of claim 1 wherein pressure sensitive adhesive further comprises polymerized units derived from at least one monomer selected from acid-functional monomers, non-acid functional polar monomers, vinyl monomers, and combinations thereof.

12. The pressure sensitive adhesive composition of claim 1 wherein the pressure sensitive adhesive further comprises a multifunctional (meth)acrylate crosslinker, a triazine crosslinker, or a combination thereof.

13. The pressure sensitive adhesive composition of claim 1 wherein the pressure sensitive adhesive exhibits a 180° degree peel adhesion to stainless steel of at least 15 N/dm after curing.

14. The pressure sensitive adhesive composition of claim 1 wherein the pressure sensitive adhesive composition comprises 0 to 1.0 wt-% of polymerized units derived from acid-functional monomers.

15. The pressure sensitive adhesive composition of claim 1 wherein the pressure sensitive adhesive composition comprises 0 to 10 wt-% of polymerized units derived from high Tg monomers.

16. The pressure sensitive adhesive composition of claim 1 wherein the pressure sensitive adhesive composition is conformable, or cleanly removable, or reusable, or reactivitable, or exhibits good adhesion to rough surfaces, or a combination thereof.

17. A pressure sensitive adhesive article comprising the pressure sensitive adhesive composition of claim 1 on a release liner.

18. A pressure-sensitive adhesive article comprising the pressure sensitive adhesive composition of claim 1 on a backing.

19-23. (canceled)

24. The pressure sensitive adhesive of claim 1 wherein Z is a reaction product of a multifunctional alcohol having 2 to 6 hydroxyl groups.

25. The pressure sensitive adhesive of claim 1 wherein the crosslinking monomer has the formula
(H₂C═C(R¹)(CH₂)O)ₓL²
wherein L² is a linear or branched (C₁-C₁₂)alkylene optionally comprising one or more substituents such as hydroxyl groups or alkoxy groups;
x ranges from 2 to 6; and
R¹ is hydrogen or methyl.

26. The pressure sensitive adhesive of claim 1 wherein the crosslinking monomer has the formula
H₂C═C(R¹)(CH₂)_{y}OC(O)-L³-C(O)O(CH₂)_{y}(R¹)C═CH₂, or
H₂C═C(R¹)(CH₂)_{y}C(O)O-L³-OC(O)(CH₂)_{y}(R¹)C═CH₂)
wherein R¹ is hydrogen or methyl;
L³ is (e.g. C₁-C₂₀) alkylene, arylene, or a combination thereof; and
y ranges from 1 to 20.
